(19) United States
(12) Patent Application Publication
(10) Pub. No.: US 2024/0322409 A1
(43) Pub. Date: Sep. 26, 2024

(54) BATTERY MODULE

(71) Applicant: HONDA MOTOR CO., LTD., Tokyo (JP)

(72) Inventors: Wataru SHIMIZU, Saitama (JP); Hiroshi SAKAI, Saitama (JP); Masataka FURUYAMA, Saitama (JP); Takafumi NAGAI, Saitama (JP); Wataru HOSHIKAWA, Saitama (JP)

(21) Appl. No.: 18/585,077

(22) Filed: Feb. 23, 2024

(30) Foreign Application Priority Data
Mar. 23, 2023 (JP) 2023-046531

(51) Int. Cl. H01M 50/618; H01M 50/451; H01M 50/48

(52) U.S. Cl. CPC H01M 50/618; H01M 50/451; H01M 50/48; H01M 2200/10

(57) ABSTRACT

A battery module including a battery cell stack in which a plurality of battery cells is stacked, a container filled with a liquid and containing the battery cell stack, and a pressurizer for pressurizing the liquid that is filled in the container. The battery cells are solid-state battery cells. The battery cell stack is packaged with a packaging material. The liquid contains an oil and a heat-absorbing material. The heat-absorbing material has an endothermic reaction initiation temperature of 80° C. or greater and 190° C. or less.

This application is based on and claims the benefit of priority from Japanese Patent Application No. 2023-046531, filed on 23 Mar. 2023, the content of which is incorporated herein by reference.

### BACKGROUND OF THE INVENTION

### Field of the Invention

The present disclosure relates to a battery module.

### Related Art

Battery modules that contribute to energy efficiency have been researched and developed to ensure that many people can easily and reliably access sustainable and advanced energy.

A battery module includes, for example, a battery cell stack that is packaged with a packaging material and has a plurality of battery cells that are stacked. Here, in a case in which the battery cells are all solid-state battery cells, the battery cells expand and contract in accordance with charging and discharging of the battery module, and thus the uniformity of reaction in the battery module may be lower.

Patent Document 1 describes a lithium battery including a battery element containing a solid electrolyte, a container containing the battery element and filled with a liquid, and a pressurizing means for pressurizing the battery element at a predetermined pressure via the liquid filled in the container. Here, the solid electrolyte is a sulfide-based solid electrolyte, and the liquid is an oil. The battery element is packaged with a packaging material.
Patent Document 1: Japanese Unexamined Patent Application, Publication No. 2010-34002

### SUMMARY OF THE INVENTION

However, in the lithium battery of Patent Document 1, the liquid exists between the container and the battery element, and thus the sensitivity for detecting abnormal heat generation is lower. As a result, the time from detecting abnormal heat generation until thermal runaway is shorter. Therefore, it is necessary to lower an abnormality detection temperature, that is, to lower the upper limit of a normal use temperature.

An object of the present disclosure is to provide a battery module capable of increasing the uniformity of reaction and the abnormality detection temperature.

(1) A battery module including: a battery cell stack in which a plurality of battery cells is stacked; a container filled with a liquid and containing the battery cell stack; and a pressurizer for pressurizing the liquid that is filled in the container, in which the battery cells are solid-state battery cells, the battery cell stack is packaged with a packaging material, the liquid contains an oil and a heat-absorbing material, and the heat-absorbing material has an endothermic reaction initiation temperature of 80° C. or greater and 190° C. or less.

(2) The battery module according to aspect 1, wherein the heat-absorbing material is a high-molecular-weight compound, an inorganic salt, or an organic low-molecular-weight compound.

(3) The battery module according to aspect 1 or 2, wherein the packaging material is a laminate film.

According to the present disclosure, it is possible to provide a battery module capable of increasing the uniformity of reaction and the abnormality detection temperature.

### BRIEF DESCRIPTION OF THE DRAWINGS

FIG. 1 is a cross-sectional view illustrating an example of a battery module of a preferred embodiment of the present disclosure.

FIG. 2 is a cross-sectional view illustrating a battery cell stack of the battery module of FIG. 1.

FIG. 3 is an exploded perspective view illustrating a container of the battery module of FIG. 1.

### DETAILED DESCRIPTION OF THE INVENTION

The following describes embodiments of the present disclosure with reference to the accompanying drawings.

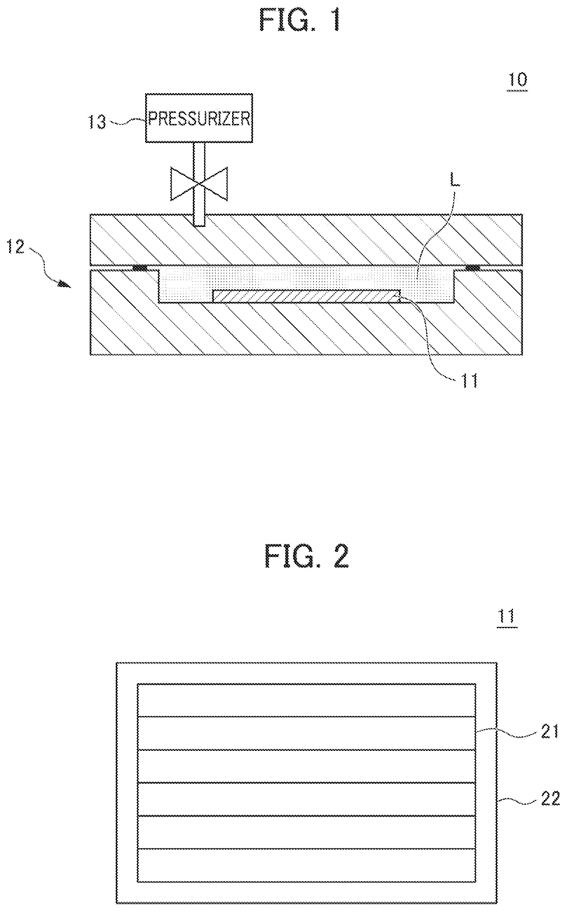

FIG. 1 illustrates an example of a battery module of a preferred embodiment of the present disclosure.

A battery module 10 includes a battery cell stack 11, a container 12 filled with a liquid L and containing the battery cell stack 11, and a pressurizer 13 for pressurizing the liquid L that fills the container 12. Here, as illustrated in FIG. 2, the battery cell stack 11 contains battery cells 21 that are stacked. The battery cell stack 11 is packaged with a packaging material 22. The battery cells 21 are solid-state battery cells. At this time, the battery cell stack 11 is uniformly pressurized by the liquid L, and thus the uniformity of reaction in the battery module 10 is higher even when the battery cells 21 expand and contract with charging and discharging.

The liquid L contains an oil and a heat-absorbing material. Here, abnormal heat generation in the solid-state battery cells is usually in the range of 120° C. to 200° C. Therefore, considering the detection error and the time required for stopping the battery module 10, the heat-absorbing material has an endothermic reaction initiation temperature of 80° C. or greater and 190° C. or less. The endothermic reaction initiation temperature is preferably 110° C. or greater and 160° C. or less. Upon the endothermic reaction initiation temperature of the heat-absorbing material being less than 80° C. or exceeds 190° C., the abnormality detection temperature of the battery module needs to be lowered. On the other hand, in the battery module 10, the endothermic reaction of the heat absorbing material contained in the liquid L increases the time from detecting abnormal heat generation until thermal runaway, and thus the battery module 10 can be safely stopped even when the abnormal detection temperature is increased. The endothermic reaction initiation temperature is measured, for example, by DSC or DTA.

Non-limiting examples of the endothermic reaction include a phase transition from a solid to a liquid and dissociation of a hydrate of an inorganic salt.

The heat absorbing material has an endothermic reaction initiation temperature of 80° C. or greater and 190° C. or less and absorbs 100 KJ/kg of heat or greater. Non-limiting examples of the heat absorbing material include any one of a high-molecular-weight compound such as polyacrylamide, polybutadiene, and high-density polyethylene and polysaccharides such as xylitol, sorbitol, erythritol, and mannitol; an inorganic salt such as AlK(SO₄)₂·12H₂O, Al₂(SO₄)₃·10H₂O, AlCl₃, MgCl₂·6H₂O, Mg(NO₃)₂·6H₂O, MgO, BaCO₃, MgO, MgSO₄·7H₂O, KNO₃, NaCl, Na₂CO₃, NaNO₂, NaNO₃; and an organic low-molecular-weight compound such as acetamide, naphthol, glutaric acid, dichloro-p-xylene, methyl fumarate, catechol, quinone, acetanilide, benzoic acid, stilbene, benzamide, and paraffin. In the heat-absorbing material, a combination of two or more may be used.

The heat absorbing material preferably lacks corrosion resistance to a contact surface with the liquid L of the battery cell stack 11.

Here, the heat absorbing material that is contained in the liquid L may be dispersed in a solid state or dissolved. The heat absorbing material that is in contact with the oil and serves as a heat medium may have any arrangement.

Non-limiting examples of the oil include a hydraulic working oil such as a petroleum working oil and a flame retardant working oil.

The pressurizer 13 can pressurize the liquid L that fills the container 12, and non-limiting examples of the pressurizer 13 include a pressurizing pump.

The liquid L that fills the container 12 is pressurized at a pressure that is appropriately selected depending on the battery cell stack 11, and is, for example, 1 MPa or greater and 100 MPa or less.

Non-limiting examples of the battery cells 21 may include an all-solid-state lithium-ion battery cell and an all-solid-state lithium-metal battery cell.

The packaging material 22 can package the battery cell stack 11, and non-limiting examples of the packaging material 22 include a laminate film. The laminate film may have, for example, a resin layer formed on a surface of a metal layer. Examples of the resin include polyethylene, polyvinyl fluoride, and polyvinylidene chloride. Examples of the metal include aluminum.

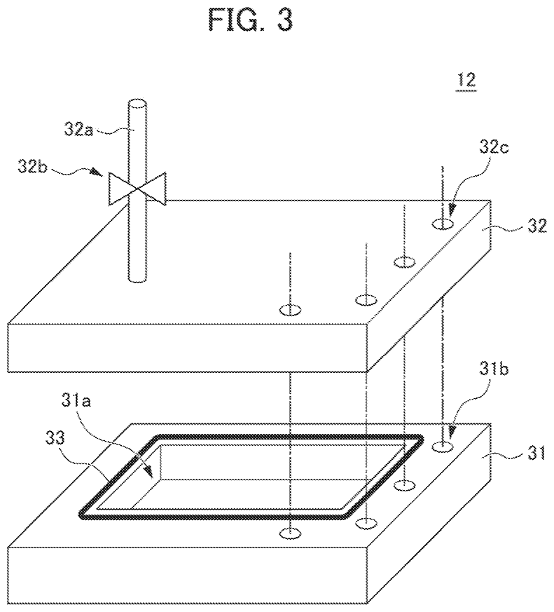

As illustrated in FIG. 3, the container 12 includes a main body portion 31 and a lid portion 32. The main body portion 31 is filled with the liquid L and has a concave portion 31a formed thereon, in which the battery cell stack 11 is accommodated. The main body portion 31 includes a seal portion 33 provided around the concave portion 31a thereof, and the seal portion 33 is interposed between the main body portion 31 and the lid portion 32 to form a sealed space. The lid portion 32 includes a pipe 32a installed therein that is used for introducing the liquid L into the concave portion 31a. The pipe 32a is provided with an on/off valve 32b for maintaining a pressurized state of the liquid L. Further, through holes 31b and 32c are formed in the main body portion 31 and the lid portion 32, respectively, and the main body portion 31 and the lid portion 32 are fixed by a bolt and a nut.

The main body portion 31 and the lid portion 32 are formed from a material that can maintain the pressurized state of the liquid L, and non-limiting examples of the material of the main body portion 31 and the lid portion 32 include a metal such as aluminum and stainless steel and a resin such as polyether ether ketone (PEEK).

The seal portion 33 is formed from a material that can maintain the pressurized state of the liquid L, and non-limiting examples of the material of the seal portion 33 include nitrile hydride rubber, acrylic rubber, silicone rubber, and fluorine rubber.

The following describes a case in which the battery cells 21 are all-solid-state lithium-metal battery cells.

The all-solid-state lithium-metal battery cell, for example, includes a positive-electrode current collector, a positive-electrode mixture layer, a solid electrolyte layer, a lithium-metal layer, and a negative-electrode current collector that are sequentially stacked.

Non-limiting examples of the positive-electrode current collector include aluminum foil.

The positive-electrode mixture layer contains a positive-electrode active material, and may further contains a solid electrolyte, a conductive auxiliary agent, a binder, and the like.

The positive-electrode active material can absorb and release lithium ions, and non-limiting examples of the positive-electrode active material include LiCoO₂, Li(Ni_{5/10}CO_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}CO_{1/3}Mn_{1/3})O₂, LiCoO₄, LiMn₂O₄, LiNiO₂, LiFePO₄, lithium sulfide, and sulfur.

The solid electrolyte that constitutes the solid electrolyte layer is formed from a material that can conduct lithium ions, and non-limiting examples of the material of the solid electrolyte include an oxide electrolyte and a sulfide electrolyte.

Non-limiting examples of the anode current collector may include copper foil.

Although the preferred embodiment of the present disclosure has been described above, the present disclosure is not limited to the above preferred embodiment, and the above preferred embodiment may be appropriately modified within the scope of the present disclosure.

### EXPLANATION OF REFERENCE NUMERALS

10 battery module
11 battery cell stack
12 container
13 pressurizer
14 buffer material
21 battery cell
22 packaging material
31 main body portion
31a concave portion
31b through holes
32 lid portion
32a pipe
32b on/off valve
32c through holes
33 seal portion
L liquid

What is claimed is:

1. A battery module comprising:
a battery cell stack in which a plurality of battery cells is stacked;
a container filled with a liquid and containing the battery cell stack; and
a pressurizer for pressurizing the liquid that is filled in the container,
wherein the battery cells are solid-state battery cells,
the battery cell stack is packaged with a packaging material,
the liquid contains an oil and a heat-absorbing material, and
the heat-absorbing material has an endothermic reaction initiation temperature of 80° C. or greater and 190° C. or less.

2. The battery module according to claim 1, wherein the heat-absorbing material is a high-molecular-weight compound, an inorganic salt, or an organic low-molecular-weight compound.

3. The battery module according to claim 1, wherein the packaging material is a laminate film.
